(19) United States
(12) Patent Application Publication
(10) Pub. No.: US 2026/0089092 A1
(43) Pub. Date: Mar. 26, 2026

(54) METHOD AND APPARATUS OF ADDRESS RESOLUTION IN A MANHATTAN GRID NETWORK

(71) Applicant: Huawei Technologies Co., Ltd., Shenzhen (CN)

(72) Inventors: William Carson McCormick, Ottawa (CA); Peter James Ashwood-Smith, Gatineau (CA)

(21) Appl. No.: 19/410,283

(22) Filed: Dec. 5, 2025

Related U.S. Application Data
(63) Continuation of application No. PCT/CN2023/099134, filed on Jun. 8, 2023.

(51) Int. Cl. H04L 45/24; H04B 7/185; H04L 9/40; H04L 45/122; H04L 45/7453

(52) U.S. Cl. CPC H04L 45/24; H04L 45/122; H04L 45/7453; H04L 63/0428; H04B 7/18521

(57) ABSTRACT

A method for forwarding a packet in a network may be performed by a network node of a first packet network and includes the following steps. Receiving the packet that includes a destination packet address of the packet, where the destination packet address indicates a terminal of a second packet network. Obtaining a Manhattan address of a Manhattan node based on a time, the destination packet address, and a lookup address function, where the terminal accesses a Manhattan network through the Manhattan node, and the Manhattan network provides a connection between the first packet network and the second packet network. Sending a Manhattan routing packet addressed to the Manhattan node to the Manhattan network, where the Manhattan routing packet includes the packet.

### CROSS-REFERENCE TO RELATED APPLICATION

This application is a continuation of International Patent Application No. PCT/CN2023/099134, filed Jun. 8, 2023, the contents of which are incorporated herein by reference in its entirety.

### TECHNICAL FIELD

This disclosure pertains generally to the field of network communications and in particular to a method and apparatus for performing address resolution in a Manhattan grid network.

### BACKGROUND

Address resolution is a common problem in networking. Address resolution is the process of acquiring a lower layer address given a higher layer address or name. The most well-known example of this is the Internet Address Resolution Protocol (ARP) used to discover the link layer address, such as a MAC address, associated with a given internet layer address, typically an IP address. ARP is used to determine an Ethernet MAC address of a node given its IP address. ARP is used together with the Domain Name System (DNS) which is used to determine the IP address of a node given its domain name.

Another type of address resolution mechanism is based on performing address resolution at a server where a well-known address is used by nodes to reach an address resolution server which can map the higher layer address to a lower layer address. A third type of address resolution mechanism is based on hashing. The hash of an upper layer address is used to locate a server which can map the upper layer address to the lower layer address. The BitTorrent distributed tracker is an example of a hash-based address resolution mechanism.

Server based address resolution mechanisms rely on the server being available and in some applications, the server may be replicated one or more times in the network. Protocols are included that allow a node to find a replica server in cases where the main server is unavailable or unreachable.

Existing approaches to address resolution may work for some applications but not others. In particular, hash based address resolution mechanisms may be designed for large networks and use very large, distributed hash tables with dynamic membership. These approaches may be overly complex for simpler networks with a largely static membership.

Other systems may include nodes that store a static address resolution mapping and rely on the actual mappings changing infrequently. Nodes will cache the mapping and only update them infrequently using defined protocols. In these systems, frequent changes in mappings lead to scalability problems as nodes can only cache mappings for a short period of time before they need to retrieve a new mapping.

A Manhattan grid network or, simply a Manhattan grid, is a known as a network geometry that is organized, physically or logically, in a rectangular grid, similar to the network of avenues and streets found on Manhattan island in New York. When used in the field of networking, the Manhattan grid geometry may be viewed as a plurality of columns being intersected by a plurality of rows. A type of Manhattan grid network may include additional links that “wrap around” or connect every node in the last column back to a corresponding node in the first column, and every node in the last row back to a corresponding row in the first row. Some networks, such as a satellite network using a topology such as a Walker Delta topology has similarities to a Manhattan grid network that wraps around the ends. These types of network may be classified as a simpler network and due to the nature of a satellite constellation in orbits, may experience frequent changes.

A satellite network may be used to bridge multiple terrestrial networks, for example, when one network is located in a remote area. For data to be sent from one terrestrial network to the other, the data must be sent to the satellite network, traverse the satellite network, and then be sent to the other terrestrial network. The routing of this data requires an appropriate address resolution mechanism.

Therefore, there exists a need for an improved address resolution mechanism that takes advantage of the characteristics of a Manhattan grid network, that alleviates the restrictions of the prior art.

This background information is provided to reveal information believed by the applicant to be of possible relevance to the present disclosure. No admission is necessarily intended, nor should be construed that any of the preceding information constitutes prior art against the present disclosure.

### SUMMARY

Embodiments provide methods, apparatus, and systems for address resolution with high availability that may be used in a Manhattan grid network. A server based address resolution mechanism may include a main address resolution server and one or more replica address resolution servers. Replica servers may be selected so that they are geometrically or topologically in proximity to the main server. In the event that the main address resolution node is unavailable or unreachable, a replica address resolution node may be discovered using a variety of methods that take advantage of the proximal location of the replica server to the main server.

In embodiments, an address resolution mechanism may include a lookup address function that may be received from an address resolution server and cached by a node. The lookup address function may be executed by a node to perform address resolution taking advantage of predictable network dynamics, as for the case of a satellite network. In the case of a satellite network, the lookup address function may also be cached for a relatively long period of time since the position of the satellites is predictable, even though satellites have constantly changing orbital speeds.

Embodiments may be suited for the case of a terrestrial network, such as an IP network, being bridged to a second, remote terrestrial IP network, through a satellite network arranged in a Manhattan grid, as in the case of a Walker Delta topology.

In accordance with an aspect of the present disclosure, there is provided a method for forwarding a packet in a network. The method may be performed by a network node of a packet network and includes the following steps. Receiving the packet that includes a destination packet address of the packet, where the destination packet address indicates a terminal of a second packet network. Obtaining a Manhattan address of a Manhattan node based on a time, the destination packet address, and a lookup address function, wherein the terminal accesses a Manhattan network through the Manhattan node, and the Manhattan network provides a connection between the packet network and the second packet network. Sending a Manhattan routing packet addressed to the Manhattan node to the Manhattan network, wherein the Manhattan routing packet includes the packet.

This provides the technical benefit of allowing address resolution to be done using a local function that may be locally cached by network nodes for a long period of time, allowing for faster address lookups than having to make an address resolution request to a server.

In further embodiments, obtaining a Manhattan address of the Manhattan node includes verifying a caching status of the lookup address function where the lookup address function. Where inputs of the lookup address function include a time and the destination packet address and an output of the lookup address function includes the Manhattan address of the Manhattan node. Furthermore, executing the lookup address function and obtaining the Manhattan address, then encapsulating the packet into a Manhattan routing packet addressed to the Manhattan node, and sending the packet to the Manhattan network.

Further embodiments include sending a first address resolution request to a distributed hash table (DHT) node of the Manhattan network where the DHT node is addressed using Manhattan network addressing. Also, receiving the lookup address function from the DHT node. The lookup address function may also be cached.

This provides the technical benefit of allowing a network node to retrieve the lookup address function from a distributed hash table (DHT) node stored in the Manhattan network. The topology of the Manhattan grid allows for the DHT node to be compactly and efficiently stored.

In further embodiments, the DHT node is a replica DHT node. The method further includes sending a second address resolution request to a second DHT node, where the DHT node is located within a geometric proximity to the second DHT node. Also, determining that the second address resolution request failed.

This provides the technical benefit of providing high availability of the DHT node information with the close proximity of the replica DHT node allowing the replica DHT node to be found quickly.

In further embodiments, the DHT node is located in geographic proximity to the second DHT node including the DHT node being located within one hop of the second DHT node.

In further embodiments, the geographic proximity to the DHT node is within a predefined number of hops of the DHT node. For example, the predefined number may be one, two, etc.

In further embodiments, the sending of the first address resolution request to the DHT node and sending the second address resolution request to a replica DHT node happens in parallel.

This provides the technical benefit of speeding up address resolution in cases where the DHT node is periodically unreachable or unavailable.

In further embodiments, the sending the second address resolution request to the replica DHT node happens in response to determining that the first address resolution request failed.

In further embodiments, an address of the DHT node is determined by a hash function that accepts a host name of the DHT node and outputs the address of the DHT node.

In further embodiments, the address of the DHT node and an address of the second DHT node are Manhattan network addresses, and the address of the DHT node is determined as an offset of a row or an offset of a column of the address of the DHT second node.

This provides the technical benefit of speeding up address resolution by incrementing or decrementing the row or column portion of the Manhattan address when the replica DHT node must be accessed.

In further embodiments, wherein the offset of a row or an offset of a column is measured in hops.

In further embodiments, the geographic proximity is determined using a breadth first search algorithm.

In further embodiments, the geographic proximity is determined using a geometric search pattern algorithm.

In further embodiments, the geographic proximity is determined using a defined search pattern algorithm.

These provide the technical benefit of allowing various choices for finding the replica DHT.

In further embodiments, the lookup address function is in the form of source code.

In further embodiments, the lookup address function is in the form of a native binary executable.

In further embodiments, the lookup address function is in the form of a binary executable of a virtual machine.

In further embodiments, the lookup address function is in the form of a compiler intermediate representation.

These provide the technical benefit of allowing various choices for storing and transmitting the lookup address function.

In further embodiments, the Manhattan network is a satellite network, the Manhattan node is a satellite in direct communication with the terminal, and the network node is a ground station in direct communication with a second satellite of the satellite network.

In further embodiments, the Manhattan network has a Walker-Delta topology.

In accordance with another aspect of the present disclosure, there is provided a network node comprising at least one processor coupled with a memory storing instructions, when the instructions are executed by the at least one processor, cause the network node to perform the method mentioned above. For example, the network node may perform methods including operations including receiving a packet including a destination packet address of the packet. Where the destination packet address indicates a terminal of a second packet network. A Manhattan network provides a connection between the packet network and the second packet network with the terminal accessing the Manhattan network through a Manhattan node. Furthermore, obtaining a Manhattan address of the Manhattan node based on a time and the destination packet address, and sending a Manhattan routing packet addressed to the Manhattan node to the Manhattan network, where the Manhattan routing packet includes the packet.

In accordance with another aspect of the present disclosure, there is provided a network or system for routing a packet. Where in the network or system comprising the network nodes (apparatuses) mentioned above.

In accordance with another aspect of the present disclosure, there is provided an apparatus including at least one processor coupled with a memory storing instructions, wherein when the instructions are executed by the at least one processor, cause the apparatus to perform any of the methods described herein.

In accordance with another aspect of the present disclosure, there is provided an program comprising instructions, wherein when the instructions are executed by an apparatus, such as a computer, cause the apparatus to perform any of the methods described herein.

In accordance with another aspect of the present disclosure, there is provided a computer-readable medium storing instructions, when the instructions are executed by an apparatus, such as a computer, cause the apparatus to perform the method disclosed herein.

In accordance with another aspect of the present disclosure, there is provided a communication system including a network node as described herein and a distributed hash table (DHT) node of a Manhattan network.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which;

FIG. 1 illustrates a schematic of a Manhattan grid network, according to an embodiment.

FIG. 2 illustrates a diagram of a satellite network system with the satellite network bridging two terrestrial IP networks, according to an embodiment.

FIG. 3 illustrates an address resolution scenario, according to an embodiment.

FIG. 4 illustrates an example of DHT replication in a Manhattan grid network, according to an embodiment.

FIG. 5 illustrates a method including address resolution using a cached lookup address function, according to an embodiment.

FIG. 6 illustrates a method including address resolution when a lookup address function is expired in the cache or is not present in the cache according to an embodiment.

FIG. 7 illustrates an electronic device, according to an embodiment, that may be used to implement any of the methods described herein.

It will be noted that throughout the appended drawings, like features are identified by like reference numerals.

### DETAILED DESCRIPTION OF ILLUSTRATIVE EMBODIMENTS

Embodiments provide methods and systems to perform address resolution with high availability that may be used in a Manhattan grid network. A server based address resolution mechanism may include a main address resolution server and one or more replica address resolution servers. Replica servers may be selected so that they are geometrically or topologically in proximity to the main server. In the event that the main address resolution node is unavailable or unreachable, a replica address resolution node may be discovered using a variety of methods that take advantage of the proximal location of the replica server to the main server.

In embodiments, an address resolution mechanism may include a lookup address function that may be received from an address resolution server and cached by a node. The lookup address function may be executed by a node to perform address resolution taking advantage of predictable network dynamics, as for the case of a satellite network. In the case of a satellite network, the lookup address function may also be cached for a relatively long period of time since the position of the satellites is predictable even through satellites have constantly changing orbital speeds.

Embodiments may be suited for network topologies when two networks of a first type, such as IP packet networks, are bridged using a network of a second type, where the network of a second type has a Manhattan grid topology. For example, in the case of a terrestrial network, such as an IP network, being bridged to a second, remote terrestrial IP network, through a satellite network arranged in a Manhattan grid, as in the case of a Walker Delta topology.

As used herein address resolution is a process of acquiring a lower layer address given a higher layer address or name. The most well-known example of this is the address resolution protocol ARP, used to determine an Ethernet MAC address of a node given the Internet Protocol (IP) address of the node, and a Domain Name System (DNS) server, which may be used to determine the IP address of a server given its domain name. ARP uses a broadcast protocol to conduct address resolution in the case that the address mapping between lower layer and higher layer address changes. Other types of address resolution mechanisms are server based. For example, when a well-known address may be used to reach an address resolution server which can map the higher layer address to a lower layer address. Another type of address resolution mechanism may be based on hashing. The hash of an upper layer address is used to locate a server which can map the upper layer address to the lower layer address. The BitTorrent distributed tracker is an example of a hash-based address resolution mechanism.

As used herein, a link is a connection between network nodes used for communications. In a Manhattan grid network, a link may connect two adjacent network nodes. Links may be unidirectional or bi-directional. A packet, or other type of message, travelling between two network nodes may travel over multiple links. For example, the packet may be sent from a source network node over a first link to an intermediate network node, and then over a second link from the intermediate network node to a destination network node. In this example, a distance between the source network node and the destination network node may be measured in “hops.” In this case, the distance is two hops since the packet is sent over two links between the source network node and the destination network node. In the case of a satellite network, a link may be between two adjacent satellites in the same orbit. A link may also be between two satellites in adjacent orbits.

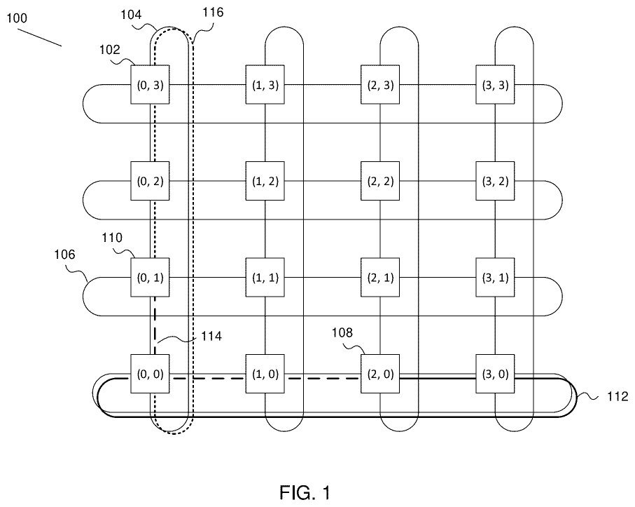

FIG. 1 illustrates a generic Manhattan grid network 100 that may be used in embodiments. As used herein, a Manhattan network, a Manhattan grid, or a Manhattan grid network refers to a network organized in a physical or logical rectangular grid. Network nodes, which may be referred to simply as nodes, may be any physical networking device that may be configured to perform routing or switching functions that involve the routing of packets and include both hardware and software components as is known in the art. For simplicity, network nodes may be referenced by their position at an intersection of a column and a row in the Manhattan grid network. For example, network node 102 is located at the intersection of column 0 and row 3 so may be referenced as network node (0, 3). Similarly, network node 108 is located at the intersection of column 2 and row 0 so may be referenced as network node (2, 0). Routing along columns may also be referred to as a routing, transmission, etc. in a vertical direction. Routing along rows may also be referred to as a routing, transmission, etc. in a horizontal direction. Network nodes may communicate with each other over links between them, illustrated by lines between the network nodes. In embodiment, nodes at the edges may have links that wraparound to the opposite edge of the grid as illustrated at the ends of columns and rows, for example link 106 that directly connects the two network nodes (0, 1) 110 and (3, 1). Link 104 directly connects network node (0, 3) 102 and (0, 0).

The term “Manhattan” grid network is based on the pattern of avenues and streets in Manhattan, New York which includes physically straight road that intersect at right angles. However, the Manhattan grid networks of embodiments described herein may be defined by the grid of network nodes and connecting links, rather than geographic locations. Network nodes are not required to be geographically arranged in straight lines, columns and rows are not required to intersect at right angles. Furthermore, the distance between network nodes do not have to be equal, though it is advantageous that the propagation delays between any two adjacent network nodes is substantially equal, or failing that, that the signal propagation delays are known.

In the Manhattan grid network, each network node has four bidirectional links leading to and from their four closest neighboring nodes in the network. In embodiments, it is advantageous that each network node has all four links operating bidirectionally, though embodiments may still be used in cases where a network node is missing a link or has a link that is temporarily inoperable.

A schematic of a Manhattan grid network (which may be referred to as a Manhattan network) is shown in FIG. 1. Network nodes, such as network node 102, in the network are given an address based on the intersection in the grid where they are located. As described herein, a network node address is written in the format (column number, row number), though other addressing formats may also be used. For example, network node 102 may be referred to as being at address (0, 3) as it is located at the intersection of column 0 and row 3.

As illustrated, the network “wraps around” at the edges. Every node in the last column connects back to a corresponding node in the first column, and every node in the last row connects back to a corresponding note in the first row. For example, link 104 wraps around between network node (0, 0) and network node (0, 3). Also, link 106 wraps around between network node (0, 1) and network node (3, 1). The links that wrap around provide two routes between network nodes in the same row or column. For example, a packet being sent between network node (1, 1) and network node (3, 1) may travel horizontally to the right from network nodes (1, 1) to (2, 1), and arrive at (3, 1). A packet may also travel horizontally to the left from network nodes (1, 1) to (0, 1), and arrive at (3, 1) using link 106. Similarly, packets sent along columns may travel vertically in an upwards or downwards direction.

In embodiments, a distance metric can be defined for computing the distance between any pair of nodes in the network. A distance may be correlated with a propagation delay and be used to minimize the propagation delay of packets in the network by minimizing the distance, or minimizing the time required for the packet to travel from a source network note to a destination network node. In a network with a Manhattan grid geometry, where the distance or propagation delay between each pair of neighboring network nodes is similar, a uniform cost (nominally 1) may be assigned to each link or hop in the packet's path. This allows a distance metric that is the sum of the vertical hops between the network nodes plus the sum of the horizontal hops between the network nodes to be used. The use of a relatively simple distance metric provides the technical benefit that distances are easy to calculate and allows for routing decisions to be done quickly with limited computational resources or with lower power requirements.

Since the network “wraps around” at the edges, there are two candidate distances that may be calculated in each of the horizontal and vertical directions for a total of four distances. FIG. 1 illustrates distances for possible routes that a packet may take between nodes (0,1) 110 and (2,0) 108. For each of the possible routes, there is an associated distance and evaluating the plurality of possible routes yields a plurality of distances corresponding to those routes. In the figure, the candidate vertical distances are shown by dotted line 116 and by dashed line 114. Candidate horizontal distances are shown by dashed line 118 and solid line 112. Routing in packet networks always tries to minimize distance, so the total distance between the two network nodes 108 and 110, is the sum of the shortest horizontal distance plus the shortest vertical distance.

The candidate horizontal distances between network nodes (0,1) and (2,0) are path 112 and path 118, both with a horizontal distance of two. The candidate vertical distances between network nodes (0,1) and (2,0) are path 114 and path 116. Path 114 has a distance of 1 and path 116 has a distance of 3. Therefore, the distance metric defined as the minimum horizontal distance plus the minimum vertical distance, would be 2+1=3. Also note that in this case there are several equal cost paths between nodes (0,1) and (2,0). These paths are:

$$( 0 , 1 ) \to ( 0 , 0 ) \to ( 1 , 0 ) \to ( 2 , 0 )$$

$$( 0 , 1 ) \to ( 1 , 1 ) \to ( 1 , 0 ) \to ( 2 , 0 )$$

$$( 0 , 1 ) \to ( 1 , 1 ) \to ( 2 , 1 ) \to ( 2 , 0 )$$

$$( 0 , 1 ) \to ( 0 , 0 ) \to ( 3 , 0 ) \to ( 2 , 0 )$$

$$( 0 , 1 ) \to ( 3 , 1 ) \to ( 3 , 0 ) \to ( 2 , 0 )$$

$$( 0 , 1 ) \to ( 3 , 1 ) \to ( 2 , 1 ) \to ( 2 , 0 )$$

This scenario with multiple paths of the same cost or distance is referred to as equal-cost multipath and embodiments may make use of equal-cost multi-path routing (ECMP) routing which includes routing algorithms where packet forwarding to a single destination can occur over multiple lowest cost (“best”) paths which tie for the minimum distance using a chosen distance metric calculation.

In this disclosure, a distance represents a path between the source network node and the destination network node, multiple distances represent different paths between the source network node and the destination network node, and multiple distances with same or equal value represent different paths with same distances between the source network node and the destination network node. Hence, selecting a minimum distance presents selecting a path with a minimum distance.

The Manhattan grid topology of FIG. 1 can be used to represent a satellite constellation topologically. Each (vertical) column in the grid may correspond to an orbital plane. Each (horizontal) row in the grid may correspond to a “phase” in the orbital plane where satellites are located. Radio or optical links may be established between adjacent satellites both in the same orbital plane and in adjacent orbital planes. Within orbital columns, satellites will be moving at a similar velocity in the same direction. Between columns, satellites will periodically be “in phase”, in other words, close to satellites in adjacent columns and may form and break communications links between each other given favorable distances between them and their relative velocities.

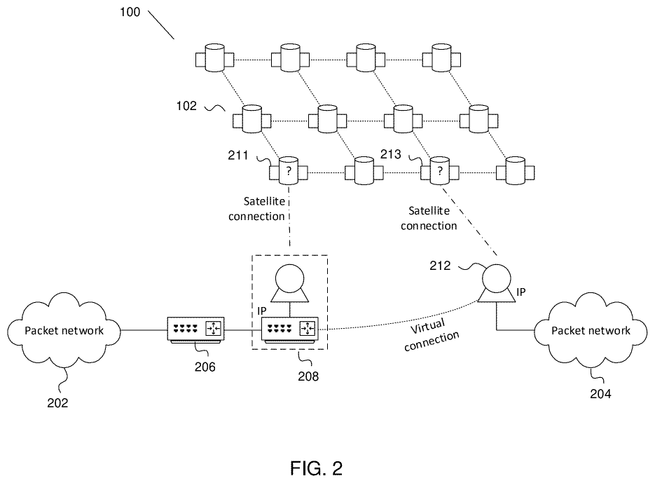

FIG. 2 illustrates a reference model for embodiments that include a Manhattan (satellite) network 100 with a Manhattan grid topology being used to bridge a packet network 202 with a second packet network 204. In this figure, the Manhattan network 100 (including a plurality of satellites arranged in a Manhattan grid topology) is used as an access network, connecting a packet network 202, the Internet, with a second packet network 204, which may be a private (IP) packet network.

A satellite terminal 212 (or simply a “terminal”) will have a public IP address assigned to it and provides a gateway for the second packet network 204 to communicate, through Manhattan network 100, with packet network 202. The terminal 212 may have a function similar to a home router, providing network address translation between its public IP address and the private IP addresses used on the local, second packet network 204. Satellite ground station 208 may have an IP address of packet network 202 assigned to it and may provide a gateway for the packet network 202 to communicate, through Manhattan network 100, with the second packet network 204. Each satellite terminal 212 in the second packet network 204 may be associated with a satellite ground station 208 in packet network 202, bridging the two networks and allowing for unidirectional or bi-directional traffic. Internet Point of Presence (POP) 206 may be a separate device or may be integrated into satellite ground station 208 and provides a point or physical location where ground station 208 is connected to the rest of the internet.

In embodiments where the Manhattan network 100 is a satellite network, the satellites, generally indicated by satellite 102, are not necessarily in a geostationary orbit and the satellite 211, in communication with satellite ground station 208, and the satellite 213, in communication with terminal 212, will periodically change. In other words, as satellites, such as satellites 211 and 213, move within their orbits, the specific satellite connected to ground station 208 and to terminal 212 will be periodically changing. For low earth orbit networks, the satellite connected to ground station 208 and to terminal 212 may be changing approximately every 10 minutes.

Therefore, in order for terminal 212 and its associated ground station 208 to communicate, they must have a mechanism to determine, that is to resolve, the address associated with the “Manhattan node” of the satellite that is presently in communication with the terminal 212 or the ground station 208. That is, for ground station 208, its Manhattan node is satellite 213, in communication with terminal 212, and ground station 208 must be able to resolve the Manhattan address of satellite 213 in the Manhattan network in order to communicate with terminal 212. Similarly, for terminal 212, its “Manhattan node” is satellite 211, and terminal 212 must be able to resolve the Manhattan address of satellite 211 in the Manhattan network in order to communicate with ground station 208.

In embodiments, the address resolution mechanism may be contained in Manhattan network 100 as this is the only network connectivity available between terminal 212 and ground station 208. Both terminal 212 and ground station 208 require some method of advertising the Manhattan address of the satellite they are connected to in the Manhattan network 100. An address resolution system should provide high availability. In the event that a satellite storing an address mapping of the address resolution mechanism for terminal 212 or a ground station 208 fails or otherwise becomes unavailable, a replica of the address mapping may be used.

Embodiments may use a hash-based mechanism to locate an address resolution mechanism for a specific packet network address of packet network 202 or packet network 204. A hash function may be used to compute the hash of the packet network address. The hash may then be mapped into a Manhattan address space to identify a specific satellite within the Manhattan network 100 where the address mapping will be stored. This hash mechanism is known as “consistent hashing”, or as a “distributed hash table” (DHT).

In embodiments, an address resolution mechanism may take the form of a “lookup address function,” that is a software module that can predict the address of a connected satellite in the Manhattan network 100. In embodiments, the lookup address function may accept a time and a destination packet address as inputs and output the Manhattan address of the Manhattan node through with a packet must be sent to in order to reach the network node indicated by the destination packet address in a packet network such as packet network 202 or packet network 204.

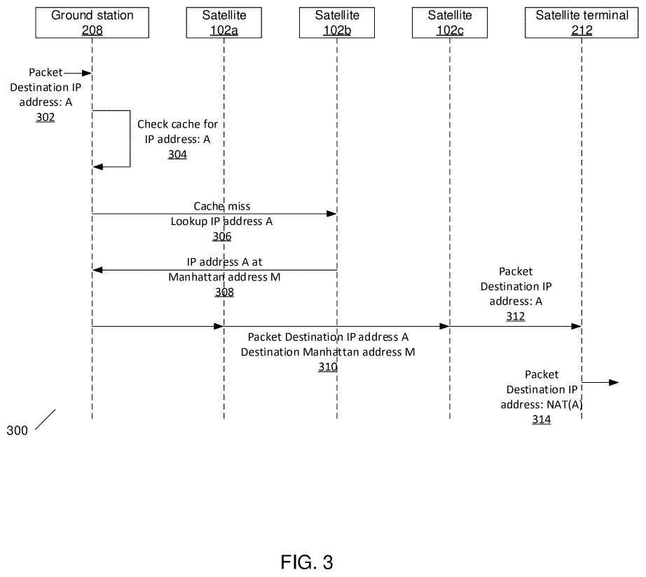

FIG. 3 illustrates a message sequence diagram illustrating an embodiment including a method for forwarding a packet in a network where the method may be performed by a network node of a packet network 202 or 204. As illustrated, the method is used to forward a packet from packet network 202 to second packet network 204. A packet may be received by ground station 208, be sent to a satellite in Manhattan network 100, be forwarded to a satellite (a “Manhattan node”) in communication with satellite terminal 212, be received by satellite terminal 212, and then forwarded to a destination network node in second packet network 204. As will be understood by those having skill in the art, the method may also be used to forward a packet from packet network 204 to second packet network 202. In this case, the packet may be received by terminal 212, be sent to a satellite in Manhattan network 100, be forwarded to a satellite (a “Manhattan node”) in communication with ground station 208, be received by ground station 208, and then forwarded to a destination network node in second packet network 202.

In embodiments, method 300 includes the following steps. In step 302, ground station 208 in packet network 202 receives an incoming IP packet including the destination address of the satellite terminal with IP address A. The packet may be received directly from a network node in packet network 202 or may receive the packet from a POP 206 which has received the packet from packet network 202. In step 304, ground station 208 checks a local cache to see if it knows or can determine the satellite address for IP address A. If it does know the satellite address, proceed to step 310. The local cache may include an address resolution mechanism that includes a lookup address function accepting a time and the destination packet address as inputs and outputting a Manhattan address of the Manhattan node. In step 304, if IP address A is not located in the local cache or the local cache does not include an address resolution mechanism such as a valid lookup address function, in step 306, the ground station 208 may prepare an address resolution request and utilize the Manhattan network to route and send the address resolution request to a satellite 102b, which may include the functionality of a DHT node and be referred to as a DHT node that includes a DHT or portion of the DHT, that is responsible for mapping IP address A. As used herein, the term “distributed hash table” (DHT) refers to a distributed data structure which consists of a set of DHT nodes that may store all or portions of the DHT. Replicas of the DHT or replicas of portions of the DHT may also be stored in DHT nodes within the Manhattan network 100. In step 308, the address resolution satellite containing the DHT node 102b, prepares an address resolution response and sends it back to ground station 208. Ground station 208 stores the address resolution mechanism included in the address resolution response in its local cache for future use. The stored address resolution mechanism may include “a time to die” after which the status of the cached address resolution mechanism becomes “invalid.” Once an address resolution mechanism is cached in a valid state it may be used in step 310 to determine the Manhattan address of the Manhattan node 102c (corresponding to satellite 213 of FIG. 2), that is the satellite 213 in communication with satellite terminal 212. Ground station 208 encapsulates the IP packet in a satellite routing packet with the destination Manhattan address of the Manhattan node 102c in the satellite network. It sends the encapsulated packet to satellite 102a in the Manhattan network, which routes it, hop by hop, to the destination satellite 102c. In step 310, the destination Manhattan node 102c satellite removes the encapsulation, extracts the destination IP address A, and sends the packet to the destination satellite terminal 212. Finally in step 314, the satellite terminal 212 may apply NAT rules to the packet, that is, to map the destination address to a packet address of a network node within the second packet network 204, and sends it into the second packet network 204.

In embodiments, the lookup address function may be implemented using consistent hashing techniques. Hashing, or a “hash function,” maps one piece of data, such as an address or a string such as a domain name or server name, to a numerical value, such as an integer value. The value output by a hashing algorithm may be referred to as a “hash code”, or simply as a hash.”

Consistent hashing is a distributed hashing method that may operate independently of the number of servers and the size of the DHT. Embodiment may utilize consistent hashing including provisions to replicate DHTs in the Manhattan network 100. DHTs may include one or more primary DHT nodes and provisions for replica DHT nodes in the event of node failure. For a DHT node, the Manhattan node address may not be used in the lookup mapping because it has undesirable statistical properties. Instead, the lookup mapping is between the hash of the Manhattan node address and the hash of the connection Manhattan address. Replica DHT nodes may be identified based on hash proximity. For example, if a connection address stored in the hash table had a hash of X, then the lookup mapping would refer to the k nodes with hashed addresses closest to X, where k is the number of replicas to be maintained in the system.

In embodiments, a network may have multiple DHT nodes. For example, a network may have four DHT nodes and the DHT may have a replication factor of two, in other words, every entry in the DHT should be stored on 2 nodes. Each DHT node stores information including an address, such as an IP address of a packet network, and the hash of the address. For example, a node may have an IP address of 47.100.2.43, which hashes to 1456. In this example, a new DHT entry may have a key of “host.huawei.com” which hashes to a value of 4301. This DHT entry must be stored in two of the four DHT nodes, due to the replication factor of two, where a hash of their address is closest to 4301. If the four DHT nodes have the following address and hash values:
DHT node #1: Address: 47.100.2.43, hash: 1456
DHT node #2: Address: 47.87.14.99, hash: 4298
DHT node #3: Address: 47.35.41.3, hash: 1786
DHT node #4: Address: 47.65.65.234, hash: 5100

Then the two nodes with the closest hash values to 4301, the hash value of “host.huawei.com”, are DHT node #2 and DHT node #4 and these 2 nodes are the nodes where the new DHT entry will be stored.

In embodiments, various methods may be used to map an IP address to a Manhattan address. A Manhattan address may be collapsed into a compact set of integers. For example, if there are 8 orbits of 8 satellites each, then each satellite may be assigned a number between 0 and 63. A cryptographic, or other high quality hash, of the IP address may be computed and a modulus 64 value may be taken to compute the corresponding Manhattan address. Furthermore, various other enhancements may be used to accommodate changes in the constellation configuration of Manhattan network 100.

In embodiment, different metrics may be used for hash proximity such as the absolute value of the difference in the two hash values or the exclusive OR of the two hash values.

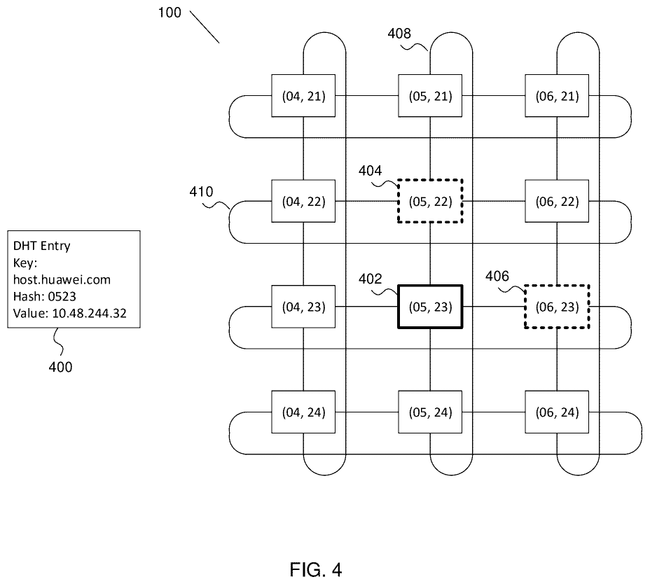

With reference to FIG. 4, in embodiments, a DHT replication method may be improved by taking advantage of the Manhattan grid network topology of Manhattan network 100. FIG. 4 illustrates a Manhattan network 100 consisting of 12 network nodes arranged in three columns and four rows. The three columns may be labelled 04, 05, and 06 while the four rows may be labelled 21, 22, 23, and 24. A Manhattan address for each network node may be constructed by combining the row label and the column label. For example, the network node located at the intersection of column 06 and row 22 may be assigned the Manhattan address (06, 22). Each column, such as column 408, may include a link that wraps around, connecting the top network node to the bottom network node. For example, top network node (05, 21) is connected with bottom network node (05, 24). Similarly, each row, such as row 410, may include a link that wraps around, connecting a network node at the left of the row to a network node at the right of the row. For example, the leftmost network node (04, 23) is connected with the rightmost network node (06, 23). In this example, the key of the new DHT entry 400 hashes to 0523, so the network node with Manhattan address (05, 23) serves as the primary storage location for this new DHT entry. A network node for storing or hosting replica DHT entries may be selected based on proximity to the network node hosting the primary DHT node in the Manhattan network topology. This approach may provide an efficient solution due to the regular structure of the Manhattan network 100. In the example illustrated in FIG. 4, the replication factor, k, is set to 3. The network node 402 for the primary DHT node is Manhattan address (05, 23), indicated by a thick outline. The network nodes for replica DHT nodes are chosen as the network node 404, 1 hop up, and the network node 406, 1 hop right of the main network node 402. In this example, network node 404 has a Manhattan address of (05, 22) and network node 406 has a Manhattan address of (06, 23). Note that in the case that the Manhattan network 100 is a satellite network with a Delta-Walker constellation, “up” may be north, “down” may be south, “right” may be east, and “left” may be west.

If a network node in packet network 202 is trying to retrieve the address mapping for “host.huawei.com”, it may first calculate a hash of “host.huawei.com” to obtain Manhattan address 0523, corresponding to Manhattan network node 402 that hosts the primary DHT node. The network node may then query 0523 to obtain the mapped address. If Manhattan network node 402, Manhattan address 0523 does not reply or is unreachable, then it moves on to sequentially query the backup network nodes, for example network node 404 or network node 406, until it receives a reply. Queries to any or all of the primary DHT nodes or any replica DHT nodes may also be sent in parallel, providing lower delay at the cost of more network traffic. For example, address resolution requests may be sent first, only to a primary DHT node, or may be sent to a primary DHT and any replica DHT nodes in parallel.

In embodiments, different search strategies for finding Manhattan network replica DHT nodes storing replica DHT information may be used here. Preferably, the same search strategy is used for both storing and retrieving DHT entries. In an embodiment, a simple list of nodes may be used, e.g., up, right, etc. as discussed above. Another strategy might be to compute a breadth first search of the graph of network nodes of the Manhattan network 100. The search may start at the primary network node 100 and then search all network nodes within a predefined number of hops of the DHT node. For example, the predefined number may be one, two, etc., then search all network nodes within two hops, etc. As used herein, a “hop” is a distance between any two network nodes within the Manhattan network 100. For example, between network node (05, 23) and network node (06, 23) is a distance of 1 hop. The distance between network node (05, 23) and network node (04, 22) is a distance of 2 hops. The distance between network node (05, 23) and network node (06, 21) is a distance of 3 hops.

In embodiments, an address resolution mechanism or service may take the form of a lookup address function which may be a software module stored in a DHT node or replica DHT node of the Manhattan network 100. In the example that the Manhattan network 100 is a low earth orbit constellation with predictable dynamics, a software module may predict connections between earth stations, such as ground station 208 or terminal 212, and the Manhattan network node (i.e., the satellite) that it is connected to at any time as a function of time. An earth station as used herein may include stationary networking equipment, a person or vehicle in relatively slow motion, or even an aircraft travelling at a relatively high speed. For earth stations in motion, their location is likely to be unpredictable. However, satellites in orbit will have a constant velocity as they move through their orbits that is predictable. Absolute and relative trajectories, velocities, and locations of satellites, between satellites, and between satellites and earth stations may be predicted for all satellites in Manhattan network 100 and this may be implemented in a software lookup address function.

A lookup address function module may be stored in a DHT node (a network node) of Manhattan network 100. Network nodes of packet network 202 or packet network 204 as well as ground station 208 and terminal 212 may retrieve a lookup address function from a DHT node and cache the function in ground station 208 or satellite terminal 212 until the cached lookup address function is invalidated in the cache. However, since the trajectories of satellites in the Manhattan network will typically not change frequently, the lookup address function may be cached and valid for a long period of time, removing the need to make constant queries into the Manhattan network 100 to retrieve a newer, up-to-date lookup address function. The lookup address function could also be upgraded periodically when a better prediction of the network dynamics becomes available.

A lookup address function may be used for different types of address resolution mechanisms such as “well known address”, hashing, and flooding. “Well known address” is a server based address resolution mechanism where a well-known address is used to reach an address resolution server which can map the higher layer address to a lower layer address. Flooding may be used by an address resolution mechanism to distribute mapping information within a network. A well-known example of this is the address resolution protocol (ARP) used to determine an Ethernet MAC address of a node given its IP address, and the domain name service (DNS) which is used to determine the IP address of a server given its domain name. ARP uses a broadcast to distribute mapping information within a network or device.

In embodiments, a lookup address function software module can be as source code, a native binary executable, a binary executable for a virtual machine, or a compiler intermediate representation.

The lookup address function may be stored with a best before date or with a cache expiry time, after which the ground station 208 or the satellite terminal 212 should replace the lookup address function with a new copy from the address resolution system.

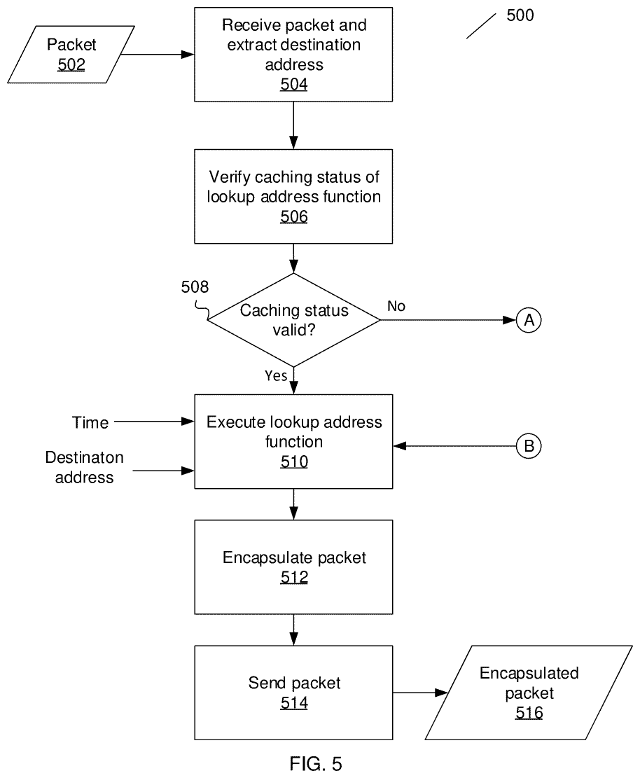

FIG. 5 illustrates a method for forwarding a packet in a network such as a network as illustrated in FIG. 2 where a packet network 202 is bridged to a second packet network 204 through a Manhattan network 100. In embodiments, the method may be performed by a network node, such as ground station 208 of packet network 202, but could also be performed by other network nodes of packet network 202, using other networking and packet forwarding techniques. The method includes step 504, receiving a packet 502 that includes a destination packet address and extracting the destination packet address. The destination packet address may indicate terminal 212 of second packet network 212 that may also provide NAT services for the second packet network 204. Manhattan network 100 provides a connection between packet network 202 and the second packet network 204. As seen in FIG. 2, terminal 212 accesses the Manhattan network 100 through a Manhattan node 213. The actual Manhattan network node (e.g., a satellite) will change over time but terminal 212 will remain in contact with Manhattan node 213 while communications are occurring. In step 506, the network node performing the method (e.g., ground station 208) will obtain the Manhattan address of Manhattan node 213 based on a time the destination packet address and a lookup address function, wherein the terminal accessing a Manhattan network through the Manhattan node, and the Manhattan network providing a connection between the packet network and the second packet network. And sending a Manhattan routing packet addressed to the Manhattan node to the Manhattan network, wherein the Manhattan routing packet includes the packet.

In embodiments, the network node will verify the caching status of a lookup address function stored therein. The lookup address function may accept inputs including a time and the destination packet address and outputting a Manhattan address of the Manhattan node 213 required to contact terminal 212. In step 508, if the caching status of the lookup address function is valid, in step 510, the network node performing the method executes the lookup address function and obtains the Manhattan address of the Manhattan node 213. In step 513, the packet is encapsulated to be routed through Manhattan network 100 to Manhattan node 213, and in step 514, the encapsulated packet 516 is sent to Manhattan node 211. Here, the encapsulated packet 516 includes the exact packet, or includes the information of the packet.

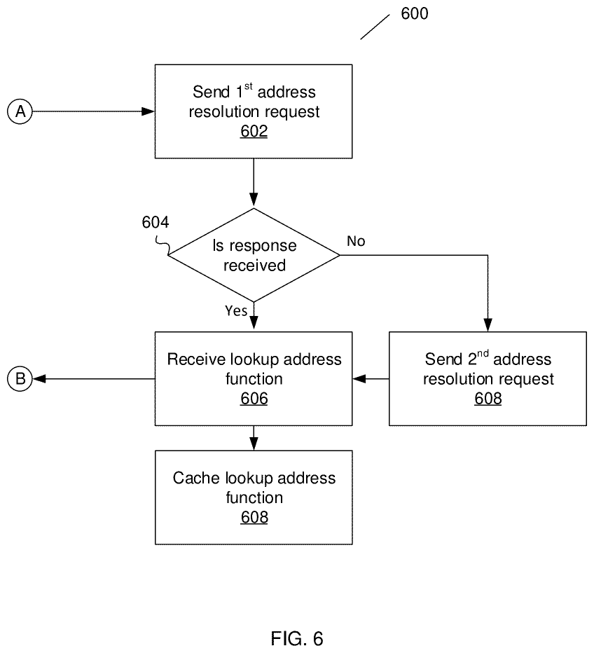

If in step 508, the caching status of the lookup address function is invalid, the method proceeds to further steps as illustrated in FIG. 6. In step 602, the network node performing the method sends a first address resolution request to a distributed hash table (DHT) of the Manhattan network 100. In step 604 an address resolution response may be received. In step 606, the lookup address function has been received and may be used in step 510. In step 608, the lookup address function is cached at the network node performing the method with a valid status. Should the address resolution response not be received correctly in step 604, in step 608, a second address resolution request may be sent to a replica DHT. Subsequent address resolution requests may also be sent until a valid lookup address function is received in step 606. As discussed previously the first, second, and any subsequent address resolution requests may be sent serially, in parallel, or using both serial and parallel transmissions. Note that in this disclosure, the words “first” and “second” do not limit a quantity and an execution sequence. For example, “first” in the first address resolution request and “second” in the second address resolution request are merely used to distinguish between different address resolution requests.

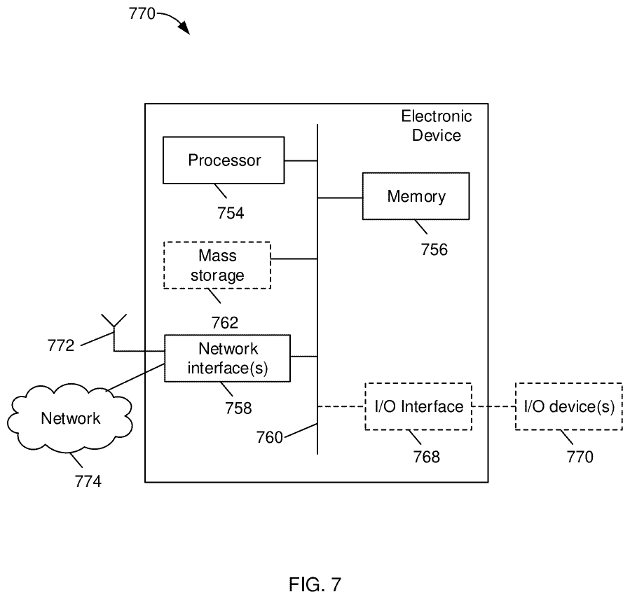

FIG. 7 illustrates an apparatus such as an electronic device 770, according to an embodiment, that may perform any or all of operations of the methods and features explicitly or implicitly described herein, according to one or more aspects of the disclosure. For example, an electronic equipped with network interfaces may be configured as network nodes of packet network 202, of packet network 204, or as any of satellite 102 in the Manhattan network 100. Electronic devices suitably equipped may also be configured as a POP 206, a ground station 208, or a terminal 212.

As shown, the apparatus 770 may include a processor 754, such as a Central Processing Unit (CPU) or specialized processors such as a Graphics Processing Unit (GPU) or other such processor unit. Optionally, the apparatus 770 may include a memory 756, non-transitory mass storage 762, input-output (I/O) interface 768, and network interface(s) 758, all of which are communicatively coupled via bi-directional bus 760. I/O interface 768 may be connected to various I/O devices(s) 770 as required by each configuration of electronic device 770. Similarly, network interface(s) 758 may interface to various network, for example network 774, which may be a packet network, or network 772, which may be a Manhattan network.

According to certain aspects, any or all of the depicted elements may be utilized, or only a subset of the elements. Further, electronic service 770 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

Memory 756 may include any type of non-transitory memory such as static random-access memory (SRAM), dynamic random-access memory (DRAM), synchronous DRAM (SDRAM), read-only memory (ROM), any combination of such, or the like. The mass storage element 762 may include any type of non-transitory storage device, such as a solid-state drive, hard disk drive, a magnetic disk drive, an optical disk drive, USB drive, or any computer program product configured to store data and machine executable program code. According to certain aspects, memory 756 or mass storage 762 may have recorded thereon statements and instructions executable by the processor 754 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

What is claimed is:

1. A method for forwarding a packet in a network, the method being performed by a network node of a first packet network, the method comprising:
receiving the packet including a destination packet address of the packet, the destination packet address indicating a terminal of a second packet network;
obtaining a Manhattan address of a Manhattan node based on a time, the destination packet address, and a lookup address function, wherein the terminal accesses a Manhattan network through the Manhattan node, and the Manhattan network provides a connection between the first packet network and the second packet network; and
sending a Manhattan routing packet addressed to the Manhattan node to the Manhattan network, wherein the Manhattan routing packet includes the packet.

2. The method of claim 1, wherein the obtaining the Manhattan address of the Manhattan node comprising:
verifying a caching status of the lookup address function, inputs of the lookup address function including the time and the destination packet address and an output of the lookup address function including the Manhattan address of the Manhattan node; and
executing the lookup address function and obtaining the Manhattan address, and
wherein the sending the Manhattan routing packet addressed to the Manhattan node to the Manhattan network comprises:
encapsulating the packet into the Manhattan routing packet addressed to the Manhattan node; and
sending the Manhattan routing packet to the Manhattan network.

3. The method of claim 1 further comprising:
sending a first address resolution request to a first distributed hash table (DHT) node of the Manhattan network, the first DHT node addressed using Manhattan network addressing; and
obtaining the lookup address function from the first DHT node.

4. The method of claim 3, wherein the first DHT node is a replica DHT node, and the method further comprises:
sending a second address resolution request to a second DHT node, wherein the first DHT node is located within a geometric proximity to the second DHT node; and
determining that the second address resolution request failed.

5. The method of claim 4, wherein the first DHT node is located within one hop of the second DHT node.

6. The method of claim 4, wherein the sending the first address resolution request to the first DHT node and sending the second address resolution request to the second DHT node happen in parallel.

7. The method of claim 4, wherein the sending the first address resolution request to the first DHT node happens in response to determining that the second address resolution request failed.

8. The method of claim 4, wherein an address of the first DHT node is determined by a hash function that accepts a host name of the first DHT node and outputs the address of the first DHT node.

9. The method of claim 4, wherein an address of the first DHT node and an address of the second DHT node are Manhattan network addresses, and the address of the first DHT node is determined as an offset of a row or an offset of a column of the address of the second DHT node.

10. The method of claim 9, wherein the offset of the row or the offset of the column is measured in hops.

11. The method of claim 4, wherein the geometric proximity is determined using a breadth first search algorithm.

12. The method of claim 4, wherein the geometric proximity is determined using one or more of: a geometric search pattern algorithm or a defined search pattern algorithm.

13. The method of claim 1, wherein the lookup address function is in a form of source code.

14. The method of claim 1, wherein the lookup address function is in a form of a native binary executable.

15. The method of claim 1, wherein the lookup address function is in a form of a binary executable of a virtual machine.

16. The method of claim 1, wherein the lookup address function is in a form of a compiler intermediate representation.

17. The method of claim 1, wherein the Manhattan network is a satellite network, the Manhattan node is a satellite in direct communication with the terminal, and the network node is a ground station in direct communication with a second satellite of the satellite network.

18. The method of claim 1, wherein the Manhattan network has a Walker-Delta topology.

19. A network node comprising at least one processor coupled with at least one memory storing instructions, wherein the instructions, when executed by the at least one processor, cause the network node to perform operations including:
receiving a packet including a destination packet address of the packet, the network node being comprised in a first packet network, the destination packet address indicating a terminal of a second packet network, a Manhattan network providing a connection between the first packet network and the second packet network, the terminal accessing the Manhattan network through a Manhattan node;
obtaining a Manhattan address of the Manhattan node based on a time and the destination packet address; and
sending a Manhattan routing packet addressed to the Manhattan node to the Manhattan network, wherein the Manhattan routing packet includes the packet.

20. A communication system comprising a network node and a distributed hash table (DHT) node of a Manhattan network, wherein the network node comprises at least one processor coupled with at least one memory storing instructions, and wherein the instructions, when executed by the at least one processor, cause the network node to perform operations including:
receiving a packet including a destination packet address of the packet, the network node being comprised in a first packet network, the destination packet address indicating a terminal of a second packet network, the Manhattan network providing a connection between the first packet network and the second packet network, the terminal accessing the Manhattan network through a Manhattan node;
obtaining a Manhattan address of the Manhattan node based on a time and the destination packet address; and
sending a Manhattan routing packet addressed to the Manhattan node to the Manhattan network, wherein the Manhattan routing packet includes the packet.
